(19) United States
(12) Patent Application Publication
(10) Pub. No.: US 2021/0240873 A1
(43) Pub. Date: Aug. 5, 2021

(54) CAD SYSTEMS USING RULE-DRIVEN PRODUCT AND MANUFACTURING INFORMATION

(71) Applicant: Siemens Industry Software Inc., Plano, TX (US)

(72) Inventors: James Darrow Linder, Brea, CA (US); Michael Rebrukh, Coto de Caza, CA (US)

(21) Appl. No.: 17/052,635

(22) PCT Filed: May 24, 2018
(86) PCT No.: PCT/US2018/034339

§ 371 Date: Nov. 3, 2020

(51) Int. Cl. G06F 30/10; G06T 17/10; G06T 19/20

(52) U.S. Cl. CPC G06F 30/10; G06F 2119/18; G06T 19/20; G06T 17/10

(57) ABSTRACT

Methods for CAD operations and corresponding systems and computer-readable mediums are disclosed herein. A method includes receiving 3D solid model data of a part to be manufactured, receiving at least one rule from a rules database, applying the rule to the 3D solid model data using a rules engine, and producing an output according the rule applied to the 3D solid model data. The rule can include an extraction portion which identifies elements or features of the 3D solid model data, a logic portion that applies a condition to the identified elements or features, and an action portion that defines an action to be performed to identified elements or features that meet the condition. The output can include an annotation of product manufacturing information to elements or features of the 3D solid model data that match the rule.

### TECHNICAL FIELD

The present disclosure is directed, in general, to computer-aided design, visualization, and manufacturing systems (“CAD systems”), product lifecycle management (“PLM”) systems, and similar systems, that manage data for products and other items (collectively, “Product Data Management” systems or PDM systems).

### BACKGROUND OF THE DISCLOSURE

CAD systems are useful for designing and visualizing two-dimensional (2D) and three-dimensional (3D) models and drawings for manufacture as physical products. Improved systems are desirable.

### SUMMARY OF THE DISCLOSURE

Various disclosed embodiments include a method for CAD operations and corresponding systems and computer-readable mediums are disclosed herein. A method includes receiving 3D solid model data of a part to be manufactured, receiving at least one rule from a rules database, applying the rule to the 3D solid model data using a rules engine, and producing an output according the rule applied to the 3D solid model data. The rule can include an extraction portion which identifies elements or features of the 3D solid model data, a logic portion that applies a condition to the identified elements or features, and an action portion that defines an action to be performed to identified elements or features that meet the condition. The output can include an annotation of product manufacturing information to elements or features of the 3D solid model data that match the rule.

Various disclosed embodiments also include a data processing system including a processor. The data processing system also includes an accessible memory. The data processing system is particularly configured to perform processes as described herein.

Various disclosed embodiments further include a non-transitory computer-readable medium encoded with executable instructions that, when executed, cause one or more data processing systems to perform processes as described herein.

In some embodiments, the rules database maintains a plurality rules, each maintained as a logical graph. In some embodiments, applying the rule includes identifying elements or features of the 3D solid model data according to the rule, applying a condition to the identified elements or features according to the rule, and performing an action on the identified elements or features that meet the condition. In some embodiments, the output is a listing or data structure of elements or features of the 3D solid model data that match the rule. In some embodiments, the annotated 3D solid model data is stored in a 3D solid model for the part to be manufactured. In some embodiments, the part is manufactured according to the output. In some embodiments, the rule is received via an interaction with a user to define the rule as a rule logical graph in the rules database, and the output is produced in real time as the rule is defined.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates various elements in accordance with disclosed embodiments;

FIG. 3 illustrates a flowchart of a process in accordance with disclosed embodiments.

FIGS. 4A and 4B illustrate examples of a rule represented as a logical graph in accordance with disclosed embodiments; and

FIG. 5 illustrates a flowchart of a process in accordance with disclosed embodiments.

### DETAILED DESCRIPTION

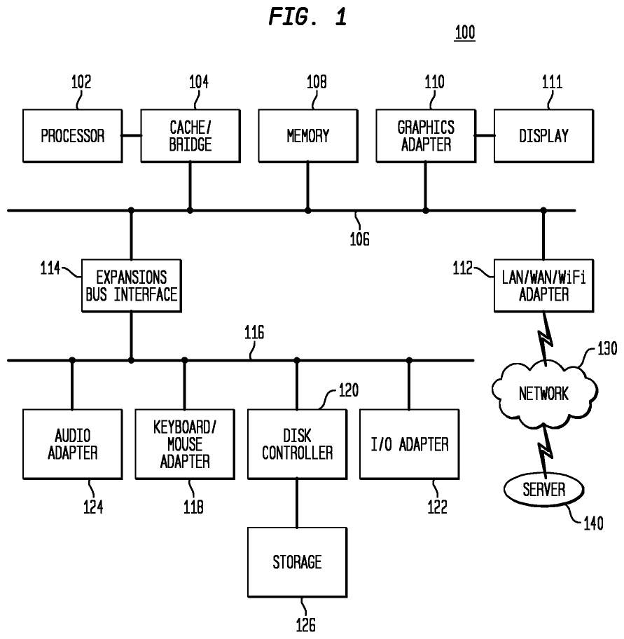

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Geometric designs provide an incomplete description of many products. In particular, geometric designs lack non-geometric information, hereinafter referred to Product and Manufacturing Information (PMI), examples of which include product finish, product assembly information, product weld information, product tolerances, product constituent material, product constituent material processing, product texture, and product color. PMI is a way to communicate non geometric attributes in a computer-based 3D model. PMI generally represents requirements that must be met in order to manufacture the part so it meets the intended fit, form and/or function. Historically, PMI existed on a 2D drawing, and PMI can also be captured in 3D models. By including PMI in an electronically-accessible product description, the design and manufacture of products can be sped and improved.

For example, if one surface of a product part requires a particular finish, then information describing the finish may be included in the PMI. The product description may then be provided to manufacturing software that electronically accesses the finish description and selects tooling capable of developing the finish on the product.

Tools for describing a product may be produced to support the creation, editing, navigation, and/or visualization of an electronically-accessible, non-geometric, product description or other PMI. A user is able to define product attributes that capture non-geometric product information and associate this non-geometric information with geometric information in an electronically-accessible model. Benefits of this may include the ability to electronically access an engineering knowledge base that already exists in external and internal databases during the design and manufacturing process, the ability to embed non-geometric product information within a geometric model, the ability to display non-geometric information and make it accessible to other applications, including third party applications, the ability to extend products by custom modeling features that are controlled by rules, and the ability to integrate engineering knowledge across different applications for analysis and design purposes. A variety of applications electronically access the PMI, including but not limited to manufacturing process planning applications, computer-aided manufacturing (CAM) packages, and tolerance analysis applications.

The ability to capture a complete set of PMI for a 3D model based on proprietary business logic is extremely time consuming and challenging. Often, customers have a very complex set of criteria that is used to decide what type and how to apply to a part. For example, a specific PMI requirement may be that, for all machines holes between 0.15 mm and 0.85 mm in aluminum parts, the standard tolerance should be +/−0.001 mm. It is apparent that, for example in a large part with thousands or tens of thousands of holes, the amount of time required to embed this PMI on the 3D model or document on paper become impractical.

With 3D models getting increasingly complex, a complete representation of PMI is required in order to perform the necessary analysis required to understand the manufacturability and variation of a manufactured part.

In some systems, specific PMI information is captured in the form of general, text based statements. These statements do not and cannot participate in any sort of PMI analysis or consumption with manufacturing technologies, and this approach requires a human to visually read and interpret the text, and then make a manual decision. Size and complexity of models often make this task impossible and very error prone, as it is easy to overlook data, miss applications, or simply tire from the volume of repetitive work.

Other systems attempt to use a simplified representation. As 3D models get larger and more complex, the ability to manually capture information in a computer based system or by hand becomes an impossible task. The ability to perform analysis operations by hand on fully specified PMI models become an impossibility. The cost-benefit tradeoff is not realized. This is sometimes solved by a specifying a limited set of the PMI information, and omitting other PMI based on assumptions that certain PMI have no impact. A limited specification is error prone and may lead to inaccurate results.

Disclosed embodiments use logic-based rules which leverage 3D model information and business logic to drive the authoring of PMI content. Since the PMI will have an established association with the 3D model, the system can create PMI intelligently so that the PMI can be understood by other digital solutions that analyze and apply their own decision making logic in other subsystems. The final products can be manufactured using the PMI.

FIG. 1 illustrates a block diagram of a data processing system in which an embodiment can be implemented, for example as a CAD or PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. Wi-Fi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, track pointer, touchscreen, etc. I/O bus 116 can also be connected to manufacturing equipment for manufacturing parts according to the processes disclosed herein.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments provide a new system capability to locate content that is manually cost prohibitive, then author or apply PMI content based on business logic or predefined criteria. The particular PMI can be unique to the business deploying the technology.

Consider one example of common business logic. A company manufactures part and drills holes in that part. The company has different machines, drills, or processes that are able to drill the holes with different precision. In a typical case, more precision generally means more expensive drills or bits. Based on business logic, such as, for example, material, fit/function of the part, and/or hole size, the business can determine factors such as the allowable tolerance for the hole, the machine or process needed to drill the hole at the desired tolerance, and/or the number of hours required to operate the machine. Using processes as disclosed herein, these factors can then be applied to the CAD 3D model data as PMI, and the part can be manufactured based on the PMI in the CAD 3D model data.

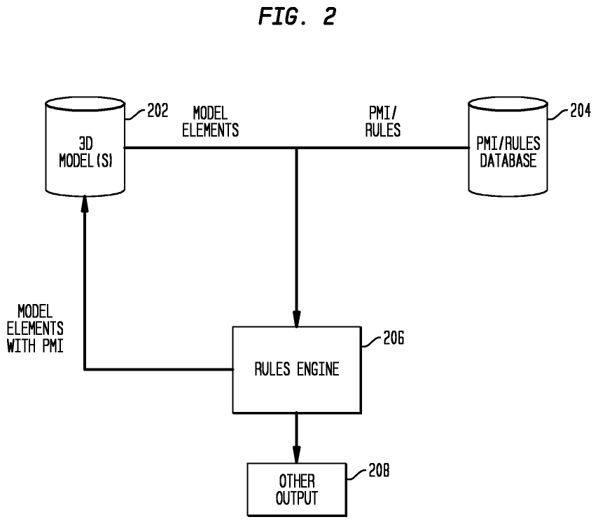

FIG. 2 illustrates various elements in accordance with disclosed embodiments. In this figure, 3D models 202 are stored, for example, in a data storage such as memory 108 or storage 126. Similarly, a PMI/rules database 204 stores PMI and rules for applying the PMI according to processes disclosed herein, and can also be are stored, for example, in a data storage such as memory 108 or storage 126. Rules engine 206 can be implemented by a processor 102, and functions to receive model elements of the 3D model(s) 202, and to receive the PMI and rules for applying the PMI. Rules engine 206 can then apply the rules in order to annotate the model elements with the PMI according to the relevant rules. In specific embodiments, “annotate” indicates that the relevant PMI is linked to and stored with the 3D data of the respective model elements. The annotated model elements are then stored back with the 3D model 202.

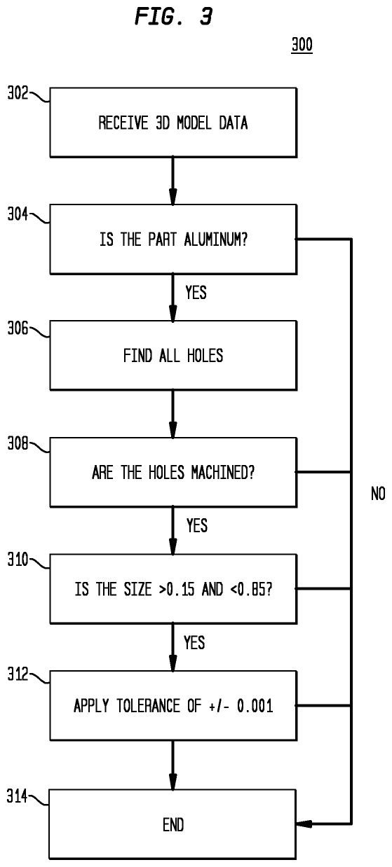

To illustrate this, consider the above example of a specific PMI requirement that, for all machines holes between 0.15 mm and 0.85 mm in aluminum parts, the standard tolerance should be +/−0.001 mm. FIG. 3 illustrates a flowchart of a process in accordance with this example. The 3D model 202 represents a part to be manufactured. The “rule” stored in PMI/rules database 204 can include multiple parts, e.g.:
when a given model element of the 3D model (that is, a component or element of the part to be manufactured) is to be manufactured with aluminum, identify all holes (an “extraction” process as described below); AND
when a machine hole in the element has a dimension between 0.15 mm and 0.85 mm (a “logic” process as described below); THEN
the machine hole should be annotated with PMI that the tolerance is +/−0.001 mm (an “action” process as described below).

In such a process example, as illustrated in FIG. 3, the system can receive the 3D model data (302).

The system can determine if the part is aluminum as part of the extraction process (304). If not, the process ends (314).

The system can find all holes in the part as part of the extraction process (306).

The system can determine if each of the holes are machined as part of the logic process (308). If not, the process ends (314).

The system can determine if each of the holes has a dimension between 0.15 mm and 0.85 mm as part of the logic process (310). If not, the process ends (314).

If each of those was true for a given hold, the system can apply a tolerance of +/−0.001 mm to the hole (312) by annotating the PMI to the hole in the 3D model data, which is then stored back in the 3D model.

Note that while, in this example, the “element” is the part in which the holes are to be made, a similar process is used when the “element” is the hole itself as represented in the model, where the first condition could be modified to “when the given model element of the 3D model (the hole) is located in a part to be manufactured with aluminum . . . . ” Equivalent rules can be stated in different manners depending on the specific condition or element being referenced.

In other cases, the rules engine 206 may produce some other output 208, which is stored in the memory 108, stored in storage 126, displayed on display 111, or transmitted to another device or process. That is, some rules in PMI/rules database 204 may be for identifying specific elements or conditions of the 3D model(s) 202, and the other output 208 is an output generated by rules engine 206 according to those rule(s), but the action taken by the rules engine 206 does not include annotating the elements in that specific process. An example of such other output 208, as in the example above, would be a display, listing, or data structure of all the identified machines holes in the aluminum part, transmitted to another system for processing, such as for updating a Bill of Materials to include a proper number of screws of the appropriate dimension or to include such number of screws of the appropriate dimension in packaging material to be packaged with the part in a consumer product.

In various embodiments, a given rule is applied to a model element, which can be a component, assembly, or subassembly of a part to be manufactured (and may be generically referred to herein as the “part”). A rule, in some embodiments, contains three components:
Extraction. This part of the rule extracts content from the part including attributes, materials, other PMI or topological content that form a “feature” (such as a hole, slot, thread, etc.). For example, “find all holes.”
Logic. This part of the rule passes the extracted data through a set of logic in order to filter, sort, or further refine the content. For example, “find all holes between 0.25 and 0.35 inches.”
Action. This part of the rule takes the final content, and performs some operation on that content. For example, “find all holes between 0.25 and 0.35 inches and apply a tolerance of 0.015 inches.”

In various embodiments, rules are constructed and stored in PMI/rules database 204 in the form of a logical graph. The logical graph represents the rule. Rules engine 206 can traverses or walks though the nodes of the graph and pass the data between the nodes as a series or collection of inputs and outputs.

For example, there may be a node in the graph call “find all holes”. This node may generate a collection of holes as output. There may be a node in the graph called apply a tolerance”. This node may require a collection of holes as input, a collection of tolerances as input, and generate a collection of PMI objects as output.

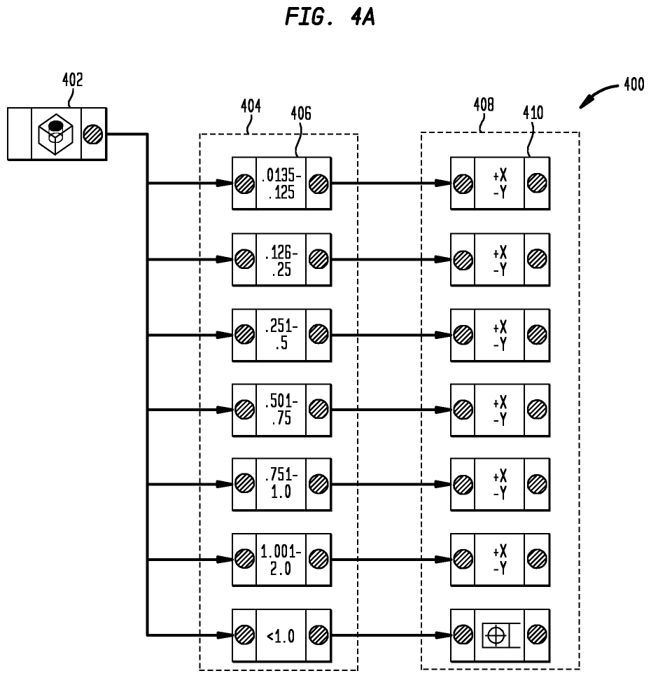

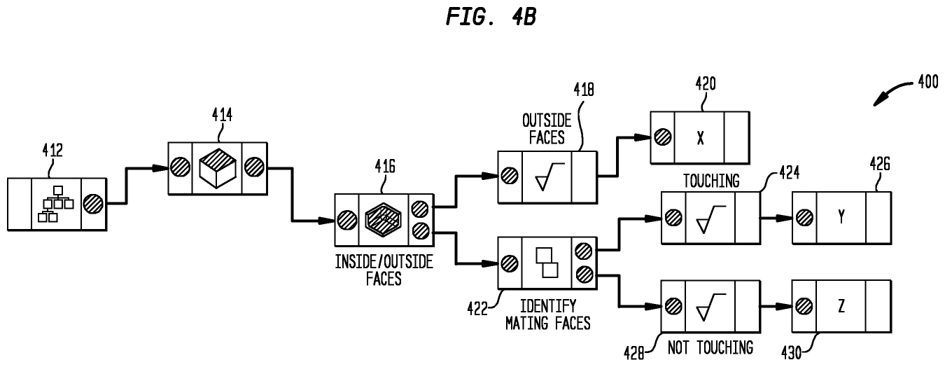

FIGS. 4A and 4B illustrate examples of such a rule represented as a logical graph 400. In FIG. 4A, the rule applies a tolerance, or positional feature control frame to a hole based on size. In the graph, node 402 defines the “extraction” condition—that the feature being operated on is a hole. Each branch 404 includes nodes that define the “logic” condition—the diameter or size of the hole. For example, node 406 of branch 404 references holes with a diameter of 0.0135-0.125 inches. Each leaf 408 defines the “action” to be taken—in this case, node 410 of leafs 408 defines the specific tolerance (as +X/−Y) of for the holes matching that branch.

FIG. 4B illustrates a more complex rule with multiple logic conditions to apply a “roughness” to a surface. The roughness is based on: a) whether or not the face is an interior, or exterior face and b) whether or not the face is touching, or mated with another face in another part. In this example, exterior faces will get a looser roughness value because their function is not significant (think of the exterior of an engine block in a car). The interior faces will get a different tolerance—because they serve a specific function—and due to friction, heat, or other factors, a different roughness value is expected.

In this example, node 414 represents the received rule set (since multiple rules may be received). Node 412 defines the “extraction” condition—that the features being operated on are faces/surfaces. Node 416 defines a second extraction condition, dividing the identified faces into inside faces and outside faces. Node 418 defines the logic condition that the face is actually an outside face. Node 420 defines the action—that the outside face should have PMI of roughness X applied. In the other branch, for inside faces, node 422 defines a third extraction condition, dividing the identified inside faces into touching (mating) or non-touching faces. Node 424 defines the logic condition that the face is actually an inside face that is touching another face. Node 426 defines the action—that the touching inside face should have PMI of roughness Y applied. Node 428 defines the logic condition that the face is actually an inside face that is not touching another face. Node 430 defines the action—that the non-touching inside face should have PMI of roughness Z applied.

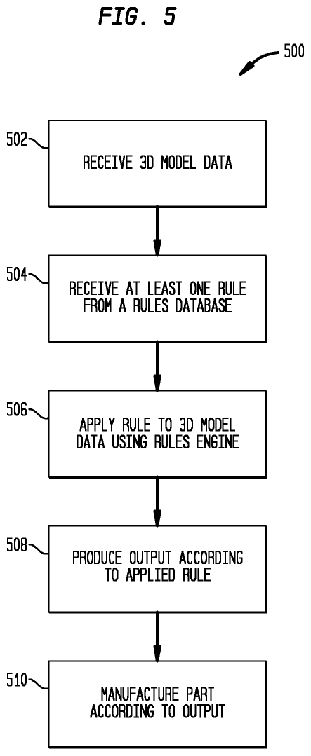

FIG. 5 illustrates a process 500 in accordance with disclosed embodiments, that can be performed by a data processing system as disclosed herein, or by another system configured to perform process as described herein, referred to generically below as the “system.”

The system receives 3D solid model data of a part to be manufactured (502). This can include an entire 3D solid model of the part or can include only a subset of the elements of the 3D solid model. Receiving, as used herein, can include loading from storage, receiving from another device or process, receiving via an interaction with a user, or otherwise.

The system receives at least one rule from a rules database (504). In various embodiments, as described above, the rule includes an extraction portion which identifies elements or features of the 3D solid model data, a logic portion that applies a condition to the identified elements or features, and action portion that defines an action to be performed to identified elements or features that meet the condition. In various embodiments, the rule is received from a rules database that maintains a plurality rules, each maintained as a logical graph. In some embodiments, the rule is received via an interaction with a user to define the rule as a rule logical graph, and the output below is produced in real time as the rule is defined.

The system applies the rule to the 3D solid model data using a rules engine (506). As described above, in some embodiments, this includes identifying elements or features of the 3D solid model data according to the rule, applying a condition to the identified elements or features according to the rule, and performing an action on the identified elements or features that meet the condition.

The system produces an output according the rule applied to the 3D solid model data (508). In some embodiments, the output is a listing or data structure of elements or features of the 3D solid model data that match the rule, and the output is stored, displayed to a user, and/or sent to another device or process. In some embodiments, the output is an annotation of product manufacturing information to elements or features of the 3D solid model data that match the rule, and the annotated 3D solid model data is stored in the 3D solid model for the part to be manufactured.

In some cases, the system can cause the part to be manufactured according to the output (510).

United States Patent Publications 2003/0182004 and 2015/0347366 are hereby incorporated by reference.

Disclosed embodiments improve the performance of the data processing system performing CAD operations. The disclosed processes provide the ability for a simple set of logic to be used to automate the authoring of hundreds or thousands of PMI objects, properly identifying where and how the PMI is applied to the 3D model data through specific criteria. The system can interact with a user to visually build rule graphs as described herein, apply the rules to the 3D model (and its elements), and display the results real time as the user is interacting with the system. The 3D model and its PMI can then be used to cause the manufacture of the physical part represented by the 3D model according to the embedded PMI.

A complete digital representation of PMI in the 3D model produced in this process enables analysis, computations, and manufacturing processes to be performed more accurately and efficiently, rather than guesses or estimates based on historical similarities since the ability to calculate and find answers by hand has previously not been possible. The processes described herein improve the entire design-to-manufacture process by enabling efficient and intelligent annotation of PMI directly into 3D model data, so that the 3D model can be manufactured accurately using the embedded PMI.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle.

1. A method comprising:
receiving, by a data processing system, 3D solid model data of a part to be manufactured;
receiving, by the data processing system, at least one rule from a rules database;
applying the rule to the 3D solid model data using a rules engine, by the data processing system; and
producing an output according the rule applied to the 3D solid model data.

2. The method of claim 1, wherein the rule includes an extraction portion which identifies elements or features of the 3D solid model data, a logic portion that applies a condition to the identified elements or features, and an action portion that defines an action to be performed to identified elements or features that meet the condition.

3. The method of claim 1, wherein the rules database maintains a plurality rules, each maintained as a logical graph.

4. The method of claim 1, wherein applying the rule includes identifying elements or features of the 3D solid model data according to the rule, applying a condition to the identified elements or features according to the rule, and performing an action on the identified elements or features that meet the condition.

5. The method of claim 1, wherein the output is a listing or data structure of elements or features of the 3D solid model data that match the rule.

6. The method of claim 1, wherein the output is an annotation of product manufacturing information to elements or features of the 3D solid model data that match the rule, and the annotated 3D solid model data is stored in a 3D solid model for the part to be manufactured.

7. The method of claim 1, further comprising causing, by the data processing system, the part to be manufactured according to the output.

8. The method of claim 1, wherein the rule is received via an interaction with a user to define the rule as a rule logical graph in the rules database, and the output is produced in real time as the rule is defined.

9. A data processing system comprising:
a processor; and
an accessible memory, the data processing system particularly configured to:
receive 3D solid model data of a part to be manufactured;
receive, at least one rule from a rules database;
apply the rule to the 3D solid model data using a rules engine; and
produce an output according the rule applied to the 3D solid model data.

10. The data processing system of claim 9, wherein the rule includes an extraction portion which identifies elements or features of the 3D solid model data, a logic portion that applies a condition to the identified elements or features, and an action portion that defines an action to be performed to identified elements or features that meet the condition.

11. The data processing system of claim 9, wherein the rules database maintains a plurality rules, each maintained as a logical graph.

12. The data processing system of claim 9, wherein applying the rule includes identifying elements or features of the 3D solid model data according to the rule, applying a condition to the identified elements or features according to the rule, and performing an action on the identified elements or features that meet the condition.

13. The data processing system of claim 9, wherein the output is a listing or data structure of elements or features of the 3D solid model data that match the rule.

14. The data processing system of claim 9, wherein the output is an annotation of product manufacturing information to elements or features of the 3D solid model data that match the rule, and the annotated 3D solid model data is stored in a 3D solid model for the part to be manufactured.

15. The data processing system of claim 9, wherein the data processing system is further configured to cause part to be manufactured according to the output.

16. The data processing system of claim 9, wherein the rule is received via an interaction with a user to define the rule as a rule logical graph in the rules database, and the output is produced in real time as the rule is defined.

17. A non-transitory computer-readable medium encoded with executable instructions that, when executed, cause one or more data processing systems to:
receive 3D solid model data of a part to be manufactured;
receive at least one rule from a rules database;
apply the rule to the 3D solid model data using a rules engine; and
produce an output according the rule applied to the 3D solid model data.

18. The computer-readable medium of claim 17, wherein the rule includes an extraction portion which identifies elements or features of the 3D solid model data, a logic portion that applies a condition to the identified elements or features, and an action portion that defines an action to be performed to identified elements or features that meet the condition.

19. The computer-readable medium of claim 17, wherein the rules database maintains a plurality rules, each maintained as a logical graph.

20. The computer-readable medium of claim 17, wherein the output is an annotation of product manufacturing information to elements or features of the 3D solid model data that match the rule, and the annotated 3D solid model data is stored in a 3D solid model for the part to be manufactured.
